(19) United States
(12) Patent Application Publication
(10) Pub. No.: US 2026/0095729 A1
(43) Pub. Date: Apr. 2, 2026

(54) UNIFIED FOUNDATIONAL MODEL FOR DIVERSE WI-FI SENSING TASKS USING CHANNEL STATE INFORMATION

(71) Applicant: Cypress Semiconductor Corporation, San Jose, CA (US)

(72) Inventors: Niall Lyons, Irvine, CA (US); Ashutosh Pandey, Irvine, CA (US); Avik Santra, Irvine, CA (US)

(73) Assignee: Cypress Semiconductor Corporation, San Jose, CA (US)

(21) Appl. No.: 19/085,246

(22) Filed: May 23, 2025

Related U.S. Application Data
(60) Provisional application No. 63/700,055, filed on Sep. 27, 2024.

(51) Int. Cl. H04W 4/38; G06N 20/00

(52) U.S. Cl. CPC H04W 4/38; G06N 20/00

(57) ABSTRACT

The present disclosure provides an approach of receiving, from an entity in a computer network, a wireless data stream including channel state information (CSI). The approach performs a tokenization process on the CSI to generate input embeddings associated with a task. The tokenization process works independently of hardware configurations, parameter configurations, or wireless communication standards of the entity The approach trains a foundational model based on the input embeddings, wherein the foundational model is trained for sensing the task. The approach generates an activity prediction associated with the task.

### CROSS REFERENCE TO RELATED APPLICATION(S)

This application claims the benefit of and priority to U.S. Provisional Application Ser. No. 63/700,055, entitled “A Unified Foundational Model for Diverse Wi-Fi Sensing Tasks using Channel State Information” and filed on Sep. 27, 2024, which is expressly incorporated by reference herein in its entirety.

### TECHNICAL FIELD

Embodiments of the present disclosure relate to sensing, and more particularly, to diverse sensing tasks using channel state information (CSI).

### BACKGROUND

The proliferation of wireless networks has opened up new avenues for passive sensing of environment and/or human activity recognition. Passive sensing of the environment and/or human activity may leverage the ubiquitous nature of wireless infrastructure. Wireless sensing may be utilized for a wide range of applications. Channel properties of a wireless link may be utilized to obtain information about the propagation environment which may allow for sensing environmental perception.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for diverse sensing tasks using CSI, in accordance with some embodiments of the present disclosure.

FIG. 2A is a block diagram that illustrates an example of a preprocessing module, in accordance with some embodiments of the present disclosure.

FIG. 2B is a block diagram that illustrates an example of a output module, in accordance with some embodiments of the present disclosure.

FIG. 3 is a block diagram that illustrates an example of a deep clustering module, in accordance with some embodiments of the present disclosure.

FIG. 4 is a block diagram that illustrates an example of a foundational model, in accordance with some embodiments of the present disclosure.

FIG. 5 is a flow diagram of a method for diverse sensing of tasks using CSI, in accordance with some embodiments.

FIG. 6 is a block diagram that illustrates an example system for diverse sensing of tasks using CSI, in accordance with some embodiments of the present disclosure.

FIG. 7 is a block diagram of an example computing device that may perform one or more of the operations described herein, in accordance with some embodiments of the present disclosure.

FIG. 8 is a block diagram 800 that illustrates an example tokenization process, in accordance with some embodiments of the present disclosure.

### DETAILED DESCRIPTION

Wireless sensing, particularly Wi-Fi® sensing using CSI, has emerged as a powerful non-invasive technique for a wide range of applications, such as sensing human activities and/or environmental changes. For example, some sensing applications include gesture recognition, human pose estimation, vital sign monitoring, or human activity recognition. CSI characterizes channel properties of a wireless link and captures fine-grained information about the propagation environment, and may be utilized for sensing human activities and environmental changes.

Despite progress in Wi-Fi sensing, current approaches face several challenges. For example, some methods are designed for specific tasks, leading to limited generalization and the need for task-specific model development. In another example, performance of these models may degrade when deployed in new environments or when faced with unseen activities, necessitating extensive data collection and model fine-tuning. In yet another example, the increasing complexity of sensing tasks demands more sophisticated models, which in turn require larger labeled datasets and computational resources.

The present disclosure addresses the challenges of Wi-Fi® sensing by employing a novel foundation model approach that scales to multiple Wi-Fi sensing tasks using CSI. The present disclosure adapts and modifies deep learning architecture (e.g., Mamba) for processing CSI data. CSI data, like natural language, exhibits complex temporal and spatial dependencies that can be effectively captured by state space models and selective mechanisms. The present disclosure incorporates CSI-specific enhancements to better handle the unique characteristics of Wi-Fi signals.

The present disclosure utilizes an innovative foundation model for scaling to multi-task Wi-Fi sensing, employing a hybrid architecture that combines transformer-based self-attention layers with state space layers. The present disclosure enables efficient processing of high-dimensional CSI data across multiple subcarriers and time steps. The present disclosure scales to multi-task learning, simultaneously addressing various Wi-Fi sensing applications, such as gesture recognition, gait analysis, human activity recognition and occupancy detection. This shared representation approach enhances generalization and facilitates efficient scalability to new scenarios with limited labeled data. The present disclosure may utilize a pre-training strategy, blending supervised and unsupervised learning objectives on a large corpus of unlabeled CSI data.

In one embodiment, the present disclosure uses a processing device to receive a wireless data stream including CSI. In one embodiment, the processing device may receive the wireless data stream including the CSI from an entity in a computer network.

The processing device performs a tokenization process on the CSI to generate input embeddings associated with a task, wherein the tokenization process works independently of hardware configurations, parameter configurations, or wireless communication standards of the entity. In some embodiments, the task includes one or more specific tasks. For example, the activity prediction determines the specific task based on the activity prediction.

The processing device trains a foundational model based on the input embeddings. The foundational model may be trained for sensing the task. In some embodiments, the foundational model includes one or more state space layers that maintain a state of the foundational model during the training of the foundational model. In some embodiments, the foundational model includes a multi-scale integration including parallel processing of different scales to obtain weights for the foundational model associated with the sensing of the task.

The processing device generates an activity prediction associated with the task. For example, the activity prediction may indicate a type of environmental change based on the CSI within the wireless data stream.

In some embodiments, the processing device processes the wireless data stream including the CSI to generate a dimensional vector compatible with the tokenization process. In some embodiments, transformations applied during the processing of the wireless data stream enhance robustness of the tokenization process. In some embodiments, processing logic generates one or more views of the CSI corresponding to a feature of the task, where each of the one or more views corresponds to a sensing characteristic associated with the feature. Each of the one or more views may be transformed based at least on a channel shuffling, a time stretch, or an affine transformation. In some embodiments, the channel shuffling performs random subcarrier permutations on the CSI. In some embodiments, the time stretch adjusts the timing of the CSI to preserve motion signatures. In some embodiments, the affine transformation scales or rotates the CSI. In some embodiments, each of the one or more views may be provided as input for an adaptive learning associated with sensing the feature based on the CSI.

As discussed herein, the present disclosure provides an approach that improves Wi-Fi sensing by using novel foundation model approach that scales to multiple Wi-Fi sensing tasks using CSI. In addition, the present disclosure provides an improvement to Wi-Fi sensing by providing versatility across diverse sensing tasks, such as but not limited to gesture recognition, gait analysis, human activity recognition, or occupancy detection, and also provides a scalable solution that outperforms task-specific models while maintaining computational efficiency.

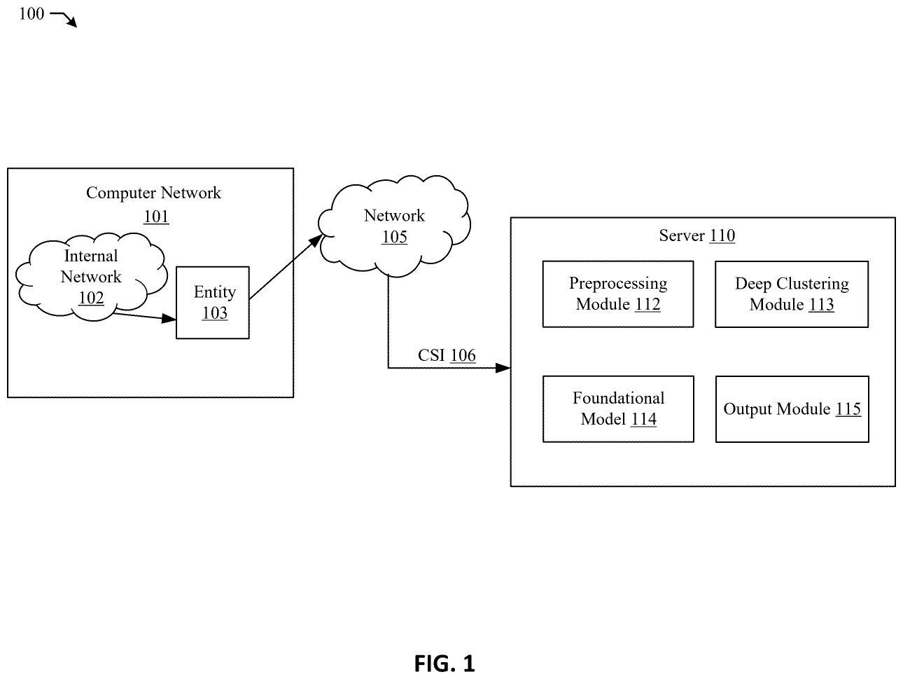

FIG. 1 is a block diagram that illustrates an example system for diverse sensing tasks using CSI, in accordance with some embodiments of the present disclosure.

System 100 includes a computer network 101, a server 110, and a network 105. The computer network 101 may include an internal network 102 and an entity 103, where the entity 103 transmits wireless data stream. The wireless data stream transmitted by the entity 103 may include Wi-Fi® wireless transmissions. However, in some embodiments, the wireless transmissions may be other wireless transmission protocols and the disclosure is not intended to be limited the examples described herein. The system 100 of FIG. 1 shows a computer network 101, but the computer network 101 may include any type of network (e.g., residential, private, business, enterprise, etc.) and the disclosure is not intended to be limited to the examples disclosed herein.

The entity 103 may transmit the wireless data stream and the server 110 may receive the wireless data stream via the network 105. The wireless data stream may include CSI 106. The server 110 includes a preprocessing module 112, a deep clustering module 113, a foundational model 114, and an output module 115. The preprocessing module 112 may obtain the CSI 106 and perform some initial processing of the CSI. For example, the preprocessing module 112 may preprocess the CSI 106 in preparation for being received by the deep clustering module 113. The deep clustering module 113 may be configured to perform a tokenization process on the CSI within the wireless data stream. In some embodiments, the CSI 106 is not preprocessed by the preprocessing module 112 and is received by the deep clustering module 113. The deep clustering module 113 may utilize the CSI, either preprocessed by the preprocessing module 112 or raw CSI, and perform a feature extraction based on the channel properties of the CSI and generates input embeddings for the foundational model 114. The foundational model 114 uses the input embeddings from the deep clustering module 113 to train or fine-tune the foundational model to perform sensing based on the CSI. The output module 115 generates an activity prediction using the results of the foundational model 114.

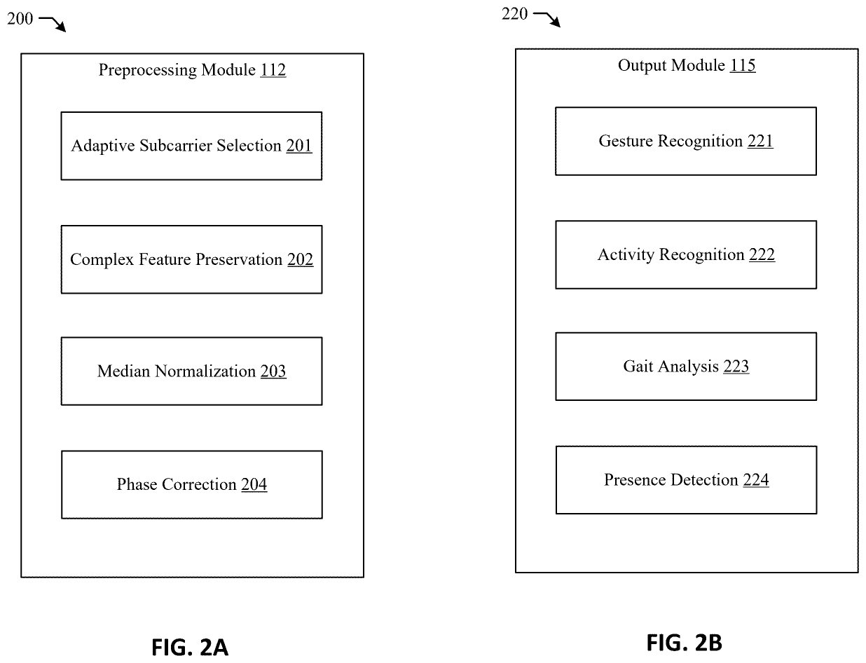

FIG. 2A is a block diagram 200 that illustrates an example of a preprocessing module 112, in accordance with some embodiments of the present disclosure.

In some embodiments, the preprocessing module 112 may process the CSI in preparation for the deep clustering module 113. The preprocessing module 112 may preprocess the CSI using various procedures. For example, block diagram 200 of FIG. 2A shows some procedures that may be implemented by the preprocessing module 112, such as an adaptive subcarrier selection 201, a complex feature preservation 202, a median normalization 203, or a phase correction 204.

In some embodiments, the preprocessing module 112 implements a series of sophisticated techniques to extract salient features from raw CSI data. We denote the complex channel frequency response as:

$$H ( f , t ) ∈ {C}^{NT \times NR}$$

where N_{T} and N_{R} represent transmit and receive antennas, respectively. The preprocessing module 112 incorporates adaptive sub-carrier selection based on signal to noise ratio (SNR) thresholding, preserving complex-valued features to capture subtle phase changes. The preprocessing module 112 employs a robust, median-based normalization technique to mitigate outlier effects, followed by linear phase correction using a state-space formulation. The process culminates in a time-domain transformation utilizing a window function (e.g., Chebychev window function) and a fast Fourier transform (FFT). This approach results in the extraction of high-fidelity, noise-resilient CSI features, critical for the diverse Wi-Fi sensing tasks, while maintaining adaptability across various hardware configurations and environmental conditions.

FIG. 2B is a block diagram 220 that illustrates an example of an output module 115, in accordance with some embodiments of the present disclosure.

The output module 115 may include task-specific heads or a classification of tasks predicted or identified from the CSI. For example, the output module 115 may include a gesture recognition 221, an activity recognition 222, a gait analysis 223, or a presence detection 224. The gesture recognition 221 may include a prediction related to whether the data within the CSI corresponds to detected gestures (e.g., human poses). The activity recognition 222 may include a prediction related to whether the data within the CSI corresponds to specific activity (e.g., human activity, movement). The gait analysis 223 may include a prediction related to whether the data within the CSI corresponds to the gait of a person (e.g., person walking, running, jogging). The presence detection 224 may include a prediction related to whether the data within the CSI corresponds to something detected as being present (e.g., human(s) present, obstacles, objects, cars, etc.).

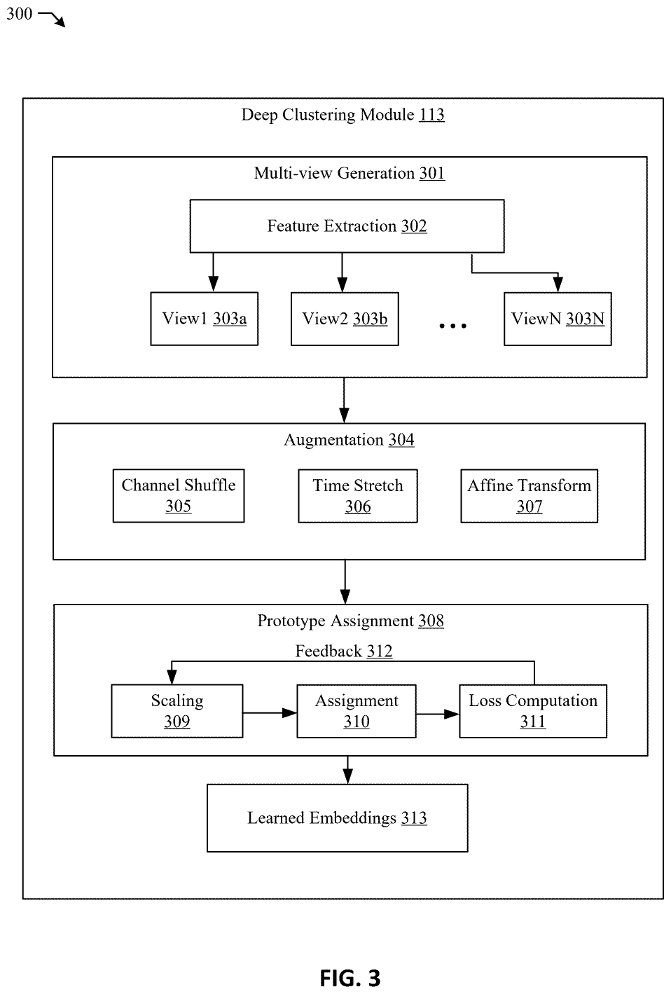

FIG. 3 is a block diagram 300 that illustrates an example of a deep clustering module, in accordance with some embodiments of the present disclosure.

The deep clustering module 113 may receive raw CSI or may receive preprocessed CSI from the preprocessing module 112 and is to perform a tokenization process. The deep clustering module 113 is analogous to tokenization in large language models, but is optimized for high-dimensional CSI data. The deep clustering module 113 employs contrastive cluster assignment to transform raw or preprocessed CSI signals into a learned, discrete vocabulary of Wi-Fi sensing primitives. The deep clustering module 113 enables data-efficient learning from unlabeled CSI, enhances cross-task generalization, and improves robustness to CSI-specific noise. The resulting feature space serves as a powerful initialization for diverse Wi-Fi sensing tasks, facilitating few-shot adaptation and scalability to multiple tasks. In some embodiments, the tokenization process performed by the deep clustering module 113 is to work across different hardware implementations, parameter configurations, and wireless standards. For example, the deep clustering module 113 may perform the tokenization process independent of the transmission scheme utilized in the transmission of the data stream comprising the CSI. The deep clustering module 113 may perform the tokenization process independent of the hardware implementation or configuration (e.g., antenna panels, diversity, etc.) of the entity transmitting the data stream comprising the CSI. The deep clustering module 113 may perform the tokenization process independent of the parameter configuration (e.g., beacon CSI or data CSI) of the CSI. In some embodiments, the deep clustering module 113 may include abstraction mechanisms used to normalize inputs from different hardware configurations and wireless standards into a unified representation.

The deep clustering module 113 may perform a multi-view generation 301 where multiple views (e.g., view1 303a, view2 303b, viewN 303N) are generated that preserve sensing characteristics. The multiple views may assist in maintaining physical signal properties of the CSI by providing a diversity of views. The multiple views may be generated based on features that have been identified via feature extraction 302. The deep clustering module 113 implements a CSI-specific augmentation strategy T to generate diverse views of each CSI sample. For input x, augmented views

$${x}_{1}^{t} , {x}_{2}^{t} , … , {x}_{V}^{t} ,$$

may be created where t˜T. The augmentation 304 includes channel shuffle 305 that performs channel shuffling, time stretch 306 that stretches timing of the CSI, or affine transform 307 that performs random affine transformations.

The deep clustering module 113 includes a prototype assignment 308 that performs an iterative refinement of the CSI. The deep clustering module 113 may include scaling 309, assignment 310, loss computation 311, where feedback 312 of the results of the loss computation 311 are fed back into the scaling 309. For example, the prototype assignment 308 may utilize an algorithm (e.g., Sinkhorn-Knopp algorithm) for entropy-regularized optimal transport, assigning features

$${z}_{i}^{t}$$

to K prototypes. This approach ensures balanced clustering for heterogeneous CSI data. In some embodiments, the iterative refinement may be based on Cij=|z′−cj|² and regularization ε yields robust, task-agnostic features. Combined with multi-view augmentation, this allows for powerful unsupervised learning framework for diverse Wi-Fi sensing tasks. The prototype assignment 308 may then generate learned embeddings 313 based on the multi-view generation 301, augmentation 304, and prototype assignment 308.

In some embodiments, the swapped prediction mechanism may be enhanced with entropy regularization to encourage diverse and informative cluster assignments. For a pair of views (s, t), the loss function is:

$$ℒ ( {z}^{s} , {z}^{t} ) = - {\sum }_{k} [ {q}^{s} ( k ) log {p}^{t} ( k ) + {q}^{t} ( k ) log {p}^{s} ( k ) ] + λ [ H ( {q}^{s} ) + H ( {q}^{t} ) ]$$

where q and p are the assigned and predicted probabilities respectively, H(•) is the entropy function, and λ controls entropy regularization strength. This formulation may promote consistency between different views while maintaining informative assignments.

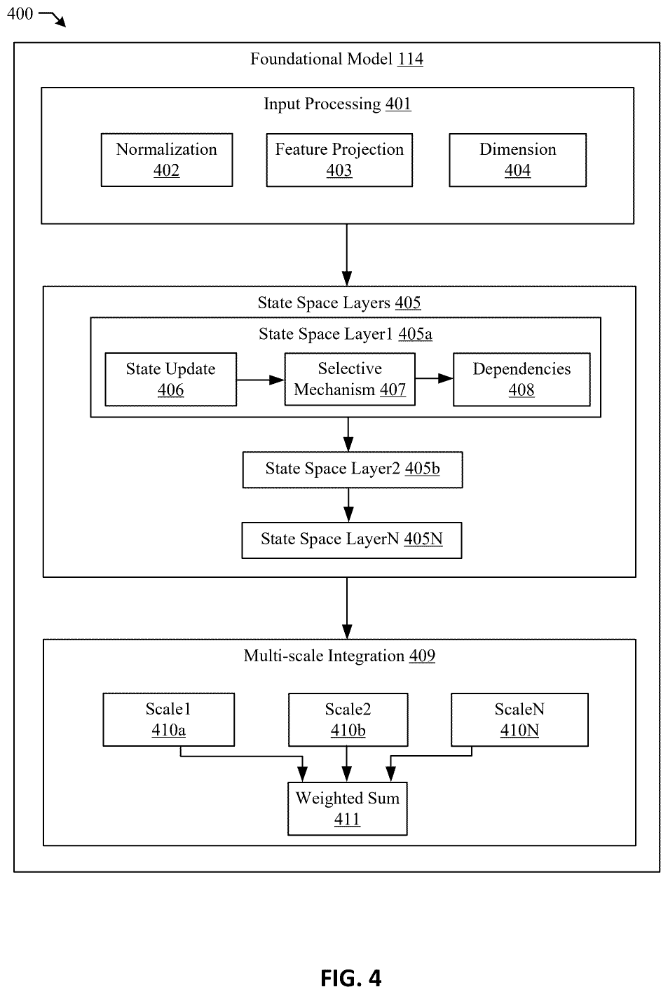

FIG. 4 is a block diagram 400 that illustrates an example foundational model, in accordance with some embodiments of the present disclosure.

The foundational model 114 may include input processing 401, state space layers 405, and multi-scale integration 409. The input processing 401 may perform processing procedures (e.g., normalization 402, feature projection 403, and/or dimension 404) on the output from the deep clustering module 113. The normalization 402 may normalize the layers, the feature projection 403 may determine which features associated with the task have been identified, and dimension 404 may adjust the dimension of the data obtained from the deep clustering module 113.

The state space layers 405 may include one or more state space layers (e.g., state space layer1 405a, state space layer2 405b, or state space layerN 405N). Each state space layer may include a state update 406, a selective mechanism 407, and dependencies 408. The state update 406 may maintain the space while the foundational model 114 is being trained. The selective mechanism 407 control information flow and capture cross-subcarrier relationships. The dependencies 408 may identify global dependencies.

The multi-scale integration 409 may include one or more scales (e.g., scale1 410a, scale2 410b, scaleN 410N) that perform parallel processing, scale-specific convolutions, or adaptive pooling. In some embodiments, where the multi-scale integration 409 includes three scales (e.g., S=3), the first scale may process the data to identify fine-grained movements (e.g., 20 ms time frame), the second scale may process the data to identify medium-term patterns (e.g., 100 ms time frame), and the third scale may process the data to identify long-term behavior (e.g., 500 ms time frame). The results of the one or more scales may be utilized to generate a weighted sum 411.

In some embodiments, the foundational model 114 leveraging its ability to capture long-range dependencies and com-plex temporal dynamics. The foundational model 114 may be based on Mamba architecture, tailored for Wi-Fi sensing, may be defined by the following state space equations:

$$\frac{d}{dt} h ( t ) = A ( x ) h ( t ) + B ( x ) u ( t ) y ( t ) = C ( x ) h ( t ) + D ( x ) u ( t )$$

where h(t) is the hidden state, u(t) is the input, y(t) is the output, and A(x), B(x), C(x), D(x) are input-dependent parameters learned through a hypernetwork approach.

In some embodiments, a CSI-specific selective mechanism may be utilized for dynamic receptive field adaptation: A(x)=diag(λ(x))+lowrank(φ(x)), where λ(x) determines state retention per feature dimension and φ(x) captures global dependencies via a low-rank update. This mechanism enables efficient modeling of CSI-specific temporal dynamics.

In some embodiments, the multi-scale integration may capture diverse temporal patterns in CSI data:

$${y}_{t} = {\sum }_{s = I}^{S} {w}_{s} ( {x}_{t} ) {y}_{t}^{s} ,$$

where yₜ^{s} is the output of the foundational model at scale s, and wₛ(xₜ) are attention-learned input-dependent weights. This allows the present disclosure to model a spectrum of temporal dynamics, from rapid gesture to slow gait patterns, enhancing the ability across various Wi-Fi sensing tasks.

In some embodiments, the foundational model 114 may be trained end-to-end using a combination of unsupervised and supervised objectives. The total loss is a dynamically weighted combination:

$${ℒ}_{total} = α ( t ) {ℒ}_{u} + ( 1 - α ( t ) ) {ℒ}_{s}$$

where α(t) is a curriculum learning schedule that gradually shifts focus from unsupervised to supervised learning as training progresses. In some embodiments, a sharpness-aware minimization (SAM) with layer-wise adaptive rate scaling (LARS) may be utilized to enhance generalization and stabilize training across diverse Wi-Fi sensing tasks. The end-to-end training approach may allow the foundational model 114 to learn general, transferable features from large amounts of unlabeled CSI data while also adapting to specific Wi-Fi sensing tasks, enabling superior performance across a wide range of applications.

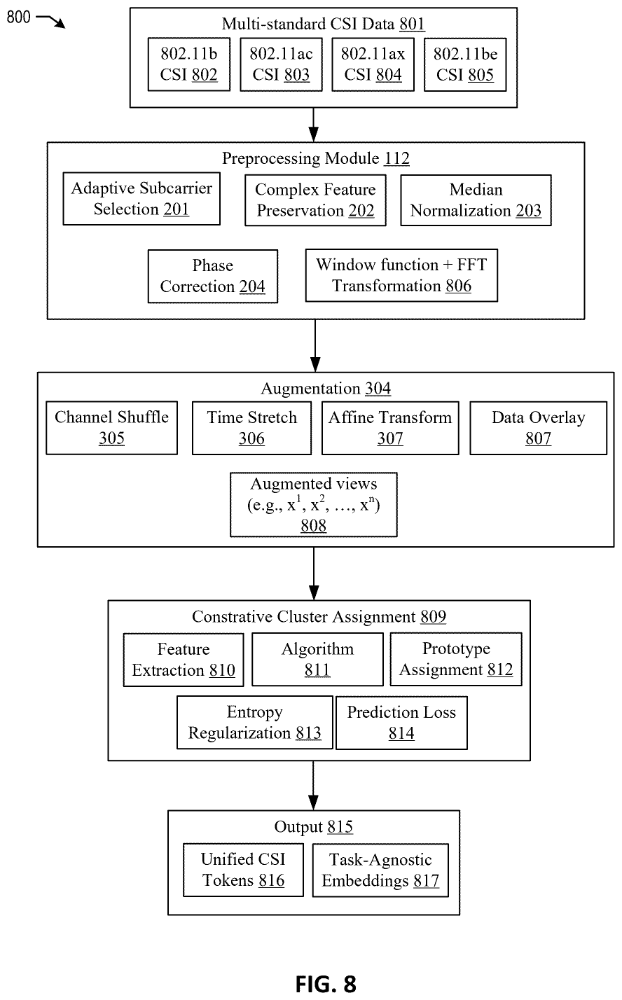

FIG. 8 is a block diagram 800 that illustrates an example tokenization process, in accordance with some embodiments of the present disclosure. The block diagram 800 may include features or elements that have been previously discussed herein, and such features or elements are not discussed to minimize duplicative information.

In some embodiments, the preprocessing module 112 may receive multi-standard CSI data 801. The multi-standard CSI data 801 may include CSI transmitted using various wireless standards, such as but not limited to 802.11b CSI 802, 802.11ac CSI 803, 802.11ax CSI 804, or 802.11be CSI 805. In some embodiments, the adaptive subcarrier selection 201 may select a subcarrier across various bandwidths. In some embodiments, the median normalization 203 may perform a normalization of the multi-standard CSI data 801 based on an antenna configuration of the entity or a CSI source type (e.g., beacons, data). In some embodiments, the preprocessing module 112 may amalgamate the multi-standard CSI data 801 across different frequency bandwidths (e.g., 20 MHz, 40 MHz) utilizing a window function and a FFT transformation 806, which allows for extraction of high-fidelity, noise resilient CSI features while maintaining adaptability across various hardware configurations and environmental conditions. In some embodiments, the window function may include a Chebychev window function or the like.

After the preprocessing of the multi-standard CSI data 801, the multi-standard CSI data 801 may be received by augmentation 304 that performs an augmentation process on the multi-standard CSI data 801. The augmentation 304, in the example of diagram 800, may further include data overlay 807 and augmented views 808 which includes a CSI acquisition. The contrastive cluster assignment 809 may obtain the output from the augmentation 304. The contrastive cluster assignment 809 includes feature extraction 810, algorithm 811, prototype assignment 812, entropy regularization 813, and prediction loss 814. The feature extraction 810 may be configured in a manner similar to features extraction 302. The algorithm 811 may utilize an algorithm (e.g., Sinkhorn-Knopp algorithm) for entropy-regularized optimal transport, which may be based on delivery traffic indication message (DTIM) periods (e.g., 1, 3, or 10). The prototype assignment 812 may perform an iterative refinement of the multi-standard CSI data 801 in a manner similar to prototype assignment 308. The entropy regularization 813 may perform diverse and informative cluster assignments, and prediction loss 814 may perform a swapped prediction loss based on the loss function described in connection with loss computation 311.

Output 815 may result in unified CSI tokens 816 and/or task-agnostic embeddings 817. The output 815 may be hardware agnostic and independent of wireless standard used for the transmission of the multi-standard CSI data 801. The unified CSI tokens 816 and/or the task-agnostic embeddings may be obtained as the output of the contrastive cluster assignment 809. The unified CSI tokens 816 and/or the task-agnostic embeddings may be associated with an activity prediction that may indicate a type of environmental change based on the multi-standard CSI data 801.

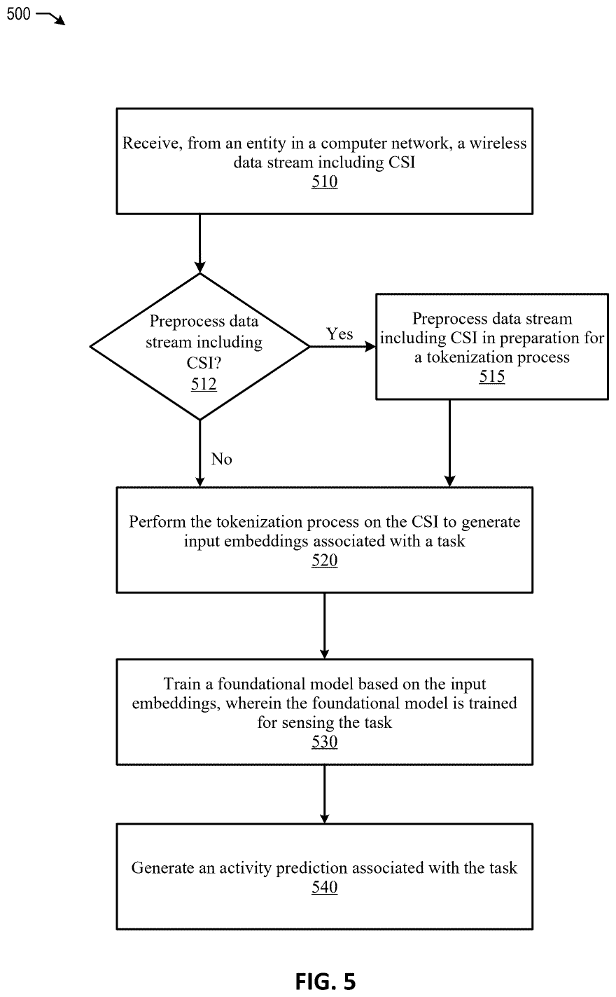

FIG. 5 is a flow diagram of a method 500 for diverse sensing of tasks using CSI, in accordance with some embodiments.

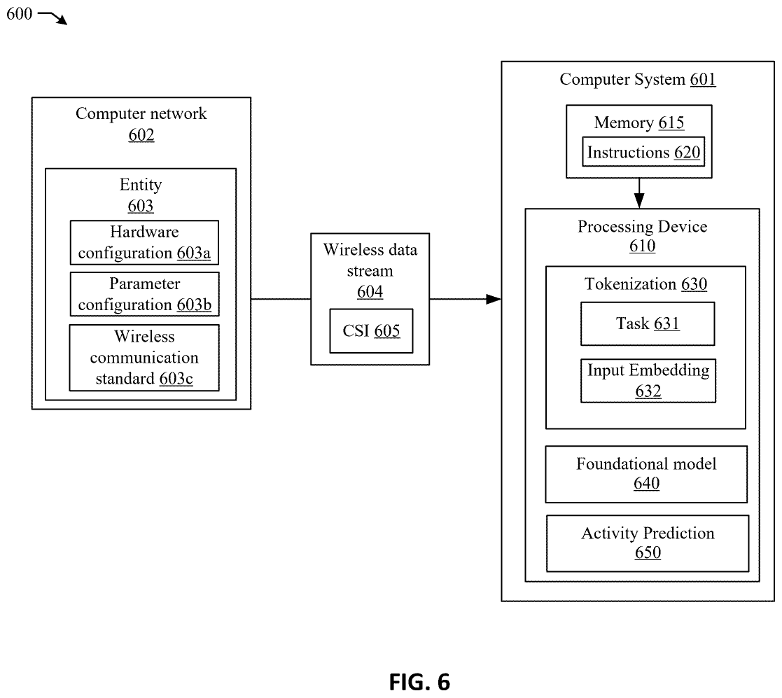

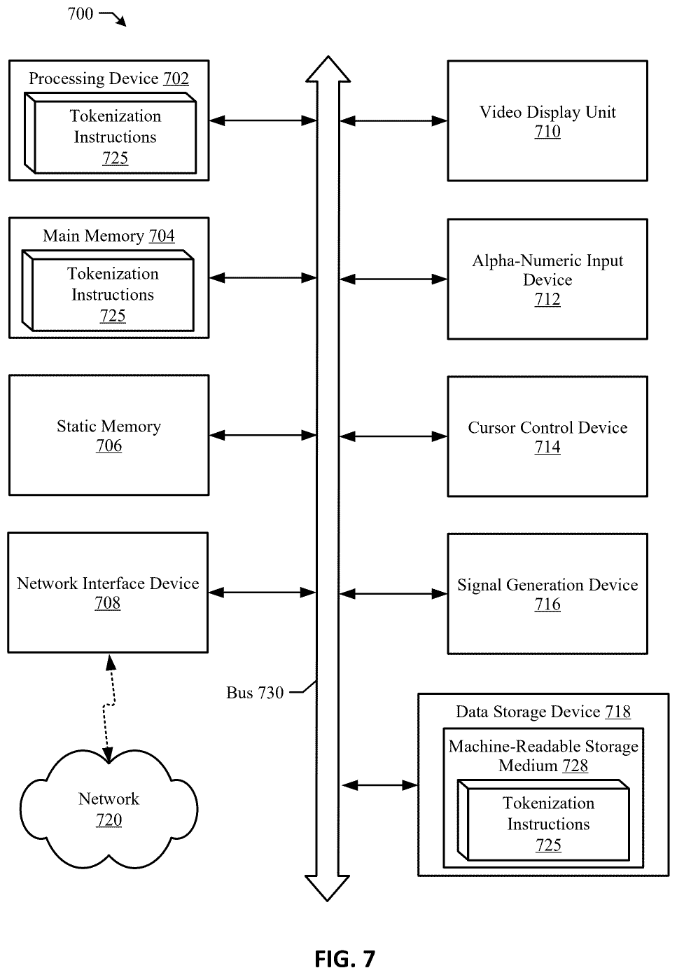

Method 500 may be performed by processing logic that may include hardware (e.g., a processing device), software (e.g., instructions running/executing on a processing device), firmware (e.g., microcode), or a combination thereof. In some embodiments, at least a portion of method 500 may be performed by server 110 (shown in FIG. 1), processing device 610 (shown in FIG. 6), processing device 702 (shown in FIG. 7), or a combination thereof.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

With reference to FIG. 5, method 500 begins at block 510, whereupon processing logic receives a wireless data stream including CSI. The processing logic may receive the wireless data stream including the CSI from an entity in a computer network.

In some embodiments, at block 512, the processing logic may determine whether the data stream including the CSI is to be preprocessed in preparation of the tokenization process. In some embodiments, if the processing logic determines that the data stream including the CSI is to be preprocessed (e.g., Yes branch), then the data stream including the CSI, at block 515, is preprocessed in preparation for the tokenization process. For example, the processing logic processes the wireless data stream including the CSI to generate a dimensional vector compatible with the tokenization process. Transformations applied during the processing of the wireless data stream may enhance robustness of the tokenization process. In some embodiments, if the processing logic determines that the data stream including the CSI is not to be preprocessed (e.g., No branch), then the data stream including the CSI may proceed to block 520. For example, the processing logic may determine that the data stream including the CSI is compatible with the tokenization process such that preprocessing may be omitted.

At block 520, processing logic performs a tokenization process on the CSI to generate input embeddings associated with a task. In some embodiments, the tokenization process may work independently of hardware configurations, parameter configurations, or wireless communication standards of the entity. For example, the tokenization process works independently of the hardware configurations or the parameter configurations of the entity associated with transmission of the wireless data stream including at least one or more of: bandwidth configurations, antenna configurations, underlying hardware implementations, a CSI acquisition configuration (e.g., solicited or unsolicited), a CSI source type (e.g., beacon CSI or data CSI), or DTIM periods (e.g., 1, 3, or 10). In some embodiments, the tokenization process projects CSI data within the input embeddings across various wireless communication standards in a consistent embedding representation. For example, the various wireless communication standards may include, but not limited to, cellular communications (e.g., 4G, 5G, 6G, etc.), Institute of Electrical and Electronics Engineers (IEEE) standards (e.g., 802.11b, 802.11ac, 802.11ax, 802.11be, etc.), or the like. In some embodiments, the task includes one or more specific tasks. For example, the activity prediction determines the specific task based on the activity prediction. In some embodiments, a tokenized representation of the task may be consistent across different downstream sensing configurations.

At block 530, processing logic trains a foundational model based on the input embeddings. The foundational model may be trained for sensing the task. In some embodiments, the foundational model includes one or more state space layers that maintain a state of the foundational model during the training of the foundational model. In some embodiments, the foundational model includes a multi-scale integration including parallel processing of different scales to obtain weights for the foundational model associated with the sensing of the task.

At block 540, processing logic generates an activity prediction associated with the task. For example, the activity prediction may indicate a type of environmental change based on the CSI within the wireless data stream.

In some embodiments, processing logic generates one or more views of the CSI corresponding to a feature of the task, wherein each of the one or more views corresponds to a sensing characteristic associated with the feature. Each of the one or more views may be transformed based at least on a channel shuffling, a time stretch, or an affine transformation. In some embodiments, the channel shuffling performs random subcarrier permutations on the CSI. In some embodiments, the time stretch adjusts the timing of the CSI to preserve motion signatures. In some embodiments, the affine transformation scales or rotates the CSI. In some embodiments, each of the one or more views may be provided as input for an adaptive learning associated with sensing the feature based on the CSI.

FIG. 6 is a block diagram 600 that illustrates an example system for diverse sensing of tasks using CSI, in accordance with some embodiments of the present disclosure.

Computer system 601 includes processing device 610 and memory 615. Memory 615 stores instructions 620 that are executed by processing device 610. The processing device is operatively coupled to the memory, to: receive, from an entity 603 in a computer network 602, a wireless data stream 604 including CSI 605. The processing device is operatively coupled to the memory, to: perform a tokenization process 630 on the CSI 605 to generate input embeddings 632 associated with a task 631. The tokenization process 630 works independently of hardware configurations 603a, parameter configurations 603b, or wireless communication standards 603c of the entity 603.

The processing device is operatively coupled to the memory, to: train a foundational model 640 based on the input embeddings 632, wherein the foundational model 640 is trained for sensing the task 631. The processing device is operatively coupled to the memory, to: generate an activity prediction 650 associated with the task 631.

FIG. 7 illustrates a diagrammatic representation of a machine in the example form of a computer system 700 within which a set of instructions, for causing the machine to perform any one or more of the methodologies discussed herein for diverse sensing of tasks using CSI.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 700 may be representative of a server.

The exemplary computer system 700 includes a processing device 702, a main memory 704 (e.g., read-only memory (ROM), flash memory, dynamic random access memory (DRAM), a static memory 706 (e.g., flash memory, static random access memory (SRAM), etc.), and a data storage device 718 which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 700 may further include a network interface device 708 which may communicate with a network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In some embodiments, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute tokenization instructions 725, for performing the operations and steps discussed herein.

The data storage device 718 may include a machine-readable storage medium 728, on which is stored one or more sets of tokenization instructions 725 (e.g., software) embodying any one or more of the methodologies of functions described herein. The tokenization instructions 725 may also reside, completely or at least partially, within the main memory 704 or within the processing device 702 during execution thereof by the computer system 700; the main memory 704 and the processing device 702 also constituting machine-readable storage media. The tokenization instructions 725 may further be transmitted or received over a network 720 via the network interface device 708.

The machine-readable storage medium 728 may also be used to store instructions to perform a method for intelligently scheduling containers, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “performing,” “training,” “generating,” “processing,” “transforming,” “shuffling,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for specific purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the method steps. The structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving, from an entity in a computer network, a wireless data stream including channel state information (CSI);
performing, by a processing device, a tokenization process on the CSI to generate input embeddings associated with a task, wherein the tokenization process works independently of hardware configurations, parameter configurations, or wireless communication standards of the entity;
training a foundational model based on the input embeddings, wherein the foundational model is trained to sense the task; and
generating an activity prediction associated with the task.

2. The method of claim 1, further comprising:
processing the wireless data stream including the CSI to generate a dimensional vector compatible with the tokenization process, wherein transformations applied during the processing of the wireless data stream enhance robustness of the tokenization process.

3. The method of claim 1, wherein the tokenization process further comprises:
generating one or more views of the CSI corresponding to a feature of the task, wherein each of the one or more views corresponds to a sensing characteristic associated with the feature.

4. The method of claim 3, wherein each of the one or more views is transformed based at least on a channel shuffling, a time stretch, or an affine transformation.

5. The method of claim 4, wherein the channel shuffling performs random subcarrier permutations on the CSI, wherein the time stretch adjusts a timing of the CSI to preserve motion signatures, wherein the affine transformation scales or rotates the CSI.

6. The method of claim 4, wherein each of the one or more views is provided as input for an adaptive learning associated with sensing the feature based on the CSI.

7. The method of claim 1, wherein the foundational model includes one or more state space layers that maintain a state of the foundational model during the training of the foundational model.

8. The method of claim 1, wherein the foundational model includes a multi-scale integration including parallel processing of different scales to obtain weights for the foundational model associated with the sensing of the task.

9. The method of claim 1, wherein the tokenization process works independently of the hardware configurations or the parameter configurations of the entity associated with transmission of the wireless data stream, wherein the hardware configurations or the parameter configurations of the entity including at least one or more of:
bandwidth configurations,
antenna configurations,
underlying hardware implementations,
a CSI acquisition configuration,
a CSI source type, or
delivery traffic indication message (DTIM) periods.

10. The method of claim 1, wherein the task includes one or more specific tasks, wherein the activity prediction determines a specific task based on the activity prediction, wherein a tokenized representation of the task is consistent across different downstream sensing configurations.

11. The method of claim 1, wherein the tokenization process projects CSI data within the input embeddings across various wireless communication standards in a consistent embedding representation.

12. A system, comprising:
a memory; and
a processing device, operatively coupled to the memory, configured to:
receive, from an entity in a computer network, a wireless data stream including channel state information (CSI);
perform, by the processing device, a tokenization process on the CSI to generate input embeddings associated with a task, wherein the tokenization process works independently of hardware configurations, parameter configurations, or wireless communication standards of the entity;
train a foundational model based on the input embeddings, wherein the foundational model is trained for sensing the task; and
generate an activity prediction associated with the task.

13. The system of claim 12, wherein the processing device is configured to:
process the wireless data stream including the CSI to generate a dimensional vector compatible with the tokenization process, wherein transformations applied during the processing of the wireless data stream enhance robustness of the tokenization process.

14. The system of claim 12, wherein to perform the tokenization process the processing device is configured to:
generate one or more views of the CSI corresponding to a feature of the task, wherein each of the one or more views corresponds to a sensing characteristic associated with the feature, wherein each of the one or more views is transformed based at least on a channel shuffling, a time stretch, or an affine transformation.

15. The system of claim 14, wherein the channel shuffling performs random subcarrier permutations on the CSI, wherein the time stretch adjusts a timing of the CSI to preserve motion signatures, wherein the affine transformation scales or rotates the CSI, wherein each of the one or more views is provided as input for an adaptive learning associated with sensing the feature based on the CSI.

16. The system of claim 12, wherein the foundational model includes one or more state space layers to maintain a state of the foundational model during the training of the foundational model, wherein the foundational model includes a multi-scale integration including parallel processing of different scales to obtain weights for the foundational model associated with the sensing of the task.

17. The system of claim 12, wherein the tokenization process works independently of the hardware configurations or the parameter configurations of the entity associated with transmission of the wireless data stream, wherein the hardware configurations or the parameter configurations of the entity including at least one or more of:
bandwidth configurations,
antenna configurations,
underlying hardware implementations,
a CSI acquisition configuration,
a CSI source type, or
delivery traffic indication message (DTIM) periods.

18. The system of claim 12, wherein the task includes one or more specific tasks, wherein the activity prediction determines the specific task based on the activity prediction, wherein a tokenized representation of the task is consistent across different downstream sensing configurations.

19. The system of claim 12, wherein the tokenization process is to project CSI data within the input embeddings across various wireless communication standards in a consistent embedding representation.

20. A non-transitory computer-readable storage medium including instructions that, when executed by a processing device, cause the processing device to:
receive, from an entity in a computer network, a wireless data stream including channel state information (CSI);
perform a tokenization process on the CSI to generate input embeddings associated with a task, wherein the tokenization process works independently of hardware configurations, parameter configurations, or wireless communication standards of the entity;
train a foundational model based on the input embeddings, wherein the foundational model is trained for sensing the task; and
generate an activity prediction associated with the task.
